(19) United States
(12) Patent Application Publication
(10) Pub. No.: US 2024/0134082 A1
(43) Pub. Date: Apr. 25, 2024

(54) INTEGRATING LABORATORY AND DOWNHOLE NUCLEAR MAGNETIC RESONANCE (NMR) MEASUREMENTS

(71) Applicants: Halliburton Energy Services, Inc., Houston, TX (US); Saudi Arabian Oil Company, Dhahran (SA)

(72) Inventors: Songhua CHEN, Katy, TX (US); Wei SHAO, Houston, TX (US); Gabriela SINGER, Houston, TX (US); Shouxiang Mark MA, Dhahran (SA); Gabor HURSAN, Dhahran (SA)

(73) Assignees: Halliburton Energy Services, Inc., Houston, TX (US); Saudi Arabian Oil Company, Dhahran (SA)

(21) Appl. No.: 17/965,494

(22) Filed: Oct. 13, 2022

(51) Int. Cl. G01V 3/32

(52) U.S. Cl. CPC G01V 3/32

(57) ABSTRACT

Systems and techniques are provided for integrating laboratory generated nuclear magnetic resonance (NMR) data and NMR logging data. An example method can include obtaining NMR logging data describing one or more downhole NMR measurements captured during a drilling operation in a borehole; modifying the NMR logging data to be compatible with a temperature correction algorithm, yielding modified NMR logging data, the temperature correction algorithm having been determined based on laboratory generated NMR data; and applying the temperature correction algorithm to the modified NMR logging data, yielding temperature corrected NMR logging data.

### TECHNICAL FIELD

The present disclosure generally relates to sensor measurements in downhole and laboratory environments. For example, aspects of the present disclosure relate to systems and techniques for integrating laboratory and downhole nuclear magnetic resonance (NMR) measurements.

### BACKGROUND

Various well operations, such as stimulation operations and drilling operations, include activities to measure formation properties using sensor data. Sensor devices can be positioned above the formation and can make surface measurements. Sensor devices can also be placed on downhole tools, such as wireline and/or drilling tools, in order to measure various downhole conditions. For example, an oil and gas company may place magnetic field sensors on a downhole tool to measure a magnetic field at the downhole location where the sensors reside. The sensors can then detect and measure a magnetic field from one or more sources, such as an Earth magnetic field, an alternating current (AC) electromagnetic source, a magnet, etc. A sensor measurement can be interpreted as a signal or set of signals, from which measurements can be determined.

### BRIEF DESCRIPTION OF THE DRAWINGS

Illustrative examples and aspects of the present application are described in detail below with reference to the following figures:

FIG. 1A is a schematic side-view of an example wireline logging environment, according to some examples of the present disclosure.

FIG. 1B is a schematic side-view of the example logging environment of FIG. 1A, according to some examples of the present disclosure.

FIG. 2 is a diagram illustrating an example logging data management system, according to some examples of the present disclosure.

FIG. 3 is a flowchart illustrating an example process for modifying nuclear magnetic resonance logging data to be compatible with a temperature correction algorithm, according to some examples of the present disclosure.

FIG. 4 is a flowchart illustrating an example process for determining whether to apply temperature correction to nuclear magnetic resonance logging data, according to some examples of the present disclosure.

FIG. 5 is a flowchart illustrating an example process for applying temperature correction to nuclear magnetic resonance logging data using a temperature correction algorithm determined based on laboratory generated nuclear magnetic resonance data, according to some examples of the present disclosure.

FIG. 6 illustrates an example computing device and hardware that can be used to implement some aspects of the disclosed technology.

### DETAILED DESCRIPTION

Various aspects and examples of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one embodiment or an embodiment, one aspect or an aspect, or one example or an example in the present disclosure can refer to the same embodiment/example/aspect/etc., or any embodiment/example/aspect/etc., and such references mean at least one of the embodiments, examples, and/or aspects.

Moreover, reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Also, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, techniques, systems, apparatuses, methods (also referred to as processes herein), non-transitory computer-readable media, and their related results according to the examples and aspects of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Well operations, such as stimulation and/or drilling operations, can include activities to measure formation properties. For example, well operations can include obtaining nuclear magnetic resonance (NMR) measurements in one or more locations of a borehole. NMR equipment can be positioned on wireline tools and/or drilling tools in a borehole of the formation. NMR equipment can also be positioned above the formation and can make surface measurements. An NMR measurement can be interpreted as a signal or set of signals from which measurements, such as NMR peak amplitudes and NMR relaxation time distributions, can be determined.

NMR relaxation time distribution of fluid in rocks exhibit temperature dependence for many subsurface formations. The mechanism of the temperature dependence may be multi-faceted, and the collective effects of multiple mechanisms may result in a large uncertainty for correcting such effects on well logging based petrophysical interpretation models. Data analytic systems that use laboratory experimental NMR measurements can be implemented to correct such temperature effects, thereby enabling more accurate NMR-based interpretation models. For example, the temperature correction can be used by incorporating the temperature dependence correlations into the ambient core analysis-based NMR petrophysical models to remove the model bias due to the use of temperature-uncorrected relaxation time distributions.

Systems, apparatuses, processes (also referred to as methods), and computer-readable media (collectively referred to herein as “systems and techniques”) are described herein for integrating laboratory generated NMR data and NMR logging data (e.g., logged downhole NMR measurements). As discussed earlier, data analytic methods based on laboratory experimental NMR measurements (e.g., laboratory generated NMR data) can be used to correct temperature effects to achieve more accurate NMR-based interpretation models. For example, the temperature correction can be used by incorporating the temperature dependence correlations into the ambient core analysis-based NMR petrophysical models to remove the model bias due to the use of temperature-uncorrected relaxation time distributions.

Various systems and techniques can be used to correct NMR core analysis data based on laboratory experimental NMR measurements. Moreover, practical applications can be implemented to improve logging data interpretation and logging derived petrophysical parameters. However, due to the difference in sensor configurations as well as characteristics of the downhole measurement environment, the data from logging measurements can carry different information than single-phase fluid-based laboratory NMR data. Therefore, a laboratory NMR core-analysis based on temperature correlation models often cannot be directly applied to the logging data.

A logging data management system alleviates these and other issues by decoupling the effects of relaxation time distribution from that of the temperature dependence in the NMR logging data. For example, the logging data management system modifies the NMR logging data to be compatible with a temperature correction algorithm determined based on laboratory generated NMR data. Once these non-temperature-based effects have been accounted for in the NMR logging data, the laboratory derived temperature dependence models can be readily applied to logging data interpretation. The non-temperature-based effects can include, for example and without limitation, the tool gradient effect, the multiphase fluid saturation effect, and the difference in signal-to-noise ratio (SNR) effect. In addition, because temperature dependence models with different rock types can be different, the logging data management system utilizes a workflow to check the NMR logging data with each model's application envelop such that the correct temperature dependent model can be applied to correct the logging data.

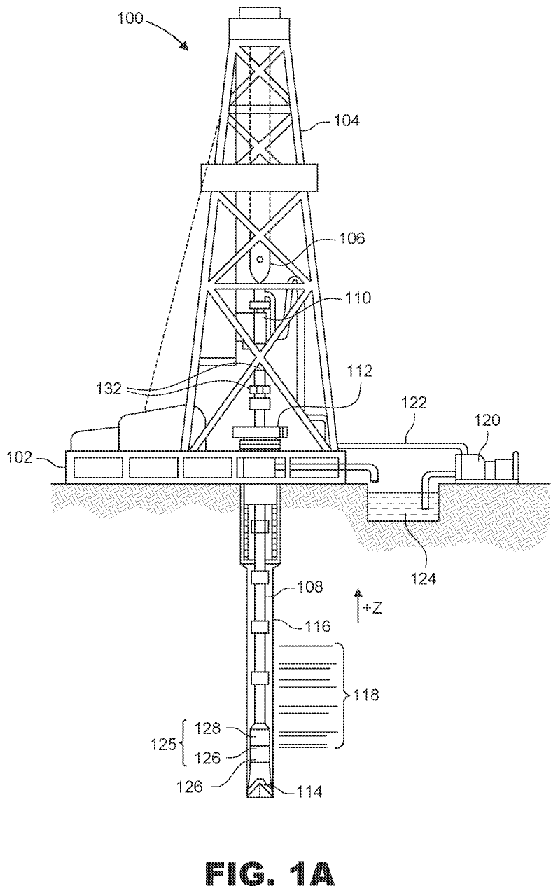

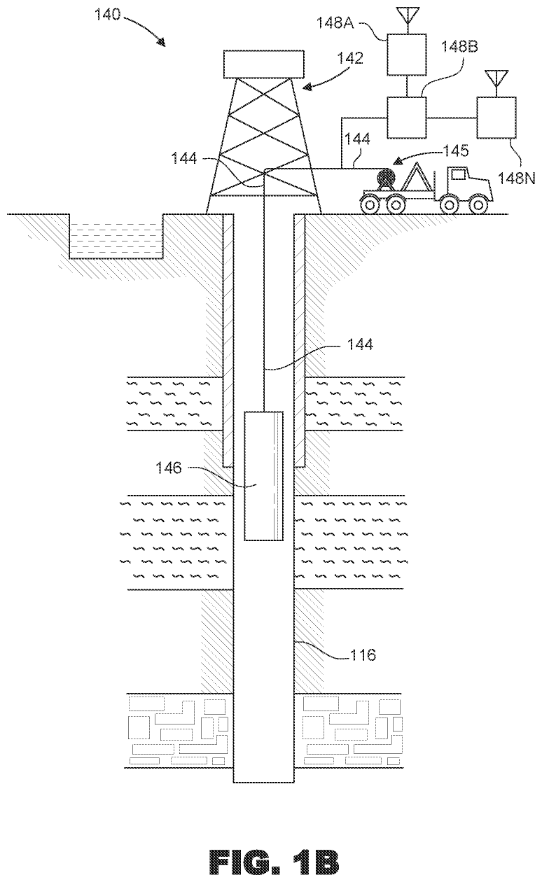

Examples of the systems and techniques described herein are illustrated in FIG. 1A through FIG. 6 and described below.

FIG. 1A is a diagram illustrating an example logging while drilling (LWD) environment, according to some examples of the present disclosure. As shown, in this example, a drilling platform 102 supports a derrick 104 that has a traveling block 106 for raising and a lowering drill string 108. A kelly 110 supports the drill string 108 as it is lowered through a rotary cable 112. A drill bit 114 is driven by a downhole motor and/or rotation of the drill string 108. As a drill bit 114 of the drill string 108 rotates, it drills a borehole 116 that passes through one or more formations 118. A pump 120 circulates drilling fluid through a feed pipe 122 to the kelly 110 downhole through the interior of the drill string 108 and orifices in the drill bit 114, back to the surface via the annulus around the drill string 108 and into a retention pit 124. The drilling fluid transports cuttings from the borehole into pit 124 and aids in maintaining borehole integrity.

A downhole tool 126 can take the form of a drill collar (e.g., a thick-walled tubular that provides weight and rigidity to aid the drilling process) or any other known and/or suitable arrangement. Further, the downhole tool 126 can include one or more logging tools such as, for example and without limitation, one or more acoustic (e.g., sonic, ultrasonic, etc.) logging tools and/or one or more other types of logging tools and/or corresponding components. The downhole tool 126 can be integrated into a bottom-hole assembly 125 near the drill bit 114. As the drill bit 114 extends the borehole through formations, the bottom-hole assembly 125 can collect logging data and/or sensor data (e.g., NMR data and/or any other logging and/or sensor data). The downhole tool 126 can include transmitters (e.g., monopole, dipole, quadrupole, etc.) to generate and transmit signals/waves into the borehole environment such as, for example and without limitation, acoustic signals/waves, radio frequency (RF) signals/waves, optical signals/waves, and/or any other signals/ways. These signals/waves propagate in and along the borehole and the surrounding formation(s) and create signal responses or waveforms, which are received/recorded by one or more receivers.

For purposes of communication, a downhole telemetry sub 128 can be included in the bottom-hole assembly 125 to transfer measurement data to a surface receiver 132 and receive commands from the surface (e.g., from a device at the surface such as a computer and/or a transmitter). Mud pulse telemetry is one example telemetry technique for transferring tool measurements to surface receivers and receiving commands from the surface. However, other telemetry techniques can also be used. Other, non-limiting example telemetry techniques that can be implemented can include fiber optic telemetry, electric telemetry, acoustic telemetry through the pipe, and electromagnetic (EM) telemetry, among others. In some aspects, the telemetry sub 128 can store logging data for later retrieval at the surface when the logging assembly is recovered.

At the surface, the surface receiver 132 can receive the uplink signal from the downhole telemetry sub 128. The surface receiver 132 can include, for example and without limitation, a wireless receiver, a computer (e.g., a laptop computer, a desktop computer, a tablet computer, a server computer, and/or any other type of computer), and/or any other device with data communication capabilities (e.g., wired and/or wireless). In some cases, the surface receiver 132 can communicate the signal from the downhole telemetry sub 128 to a data acquisition system (not shown). Such a data acquisition system can be part of the surface receiver 132 or can be a separate device such as, for example, a computer, a storage device, etc. The surface receiver 132 can include one or more processors, storage devices, input devices, output devices, memory devices, software, and/or the like. The surface receiver 132 can collect, store, and/or process the data received from tool 126 as described herein.

In some examples, the surface receiver 132 can include a single receiver or multiple receivers. In some cases, the surface receiver 132 can include a set of evenly spaced receivers or a set of receivers in any other arrangement. The surface receiver 132 can include a number of receivers arranged in an array and/or evenly spaced (or spaced in any other configuration/arrangement) apart to facilitate capturing and processing response signals at specific intervals. The response signals/waves can be analyzed to determine borehole and adjacent formation properties and/or characteristics. Depending on the implementation, other logging tools may be deployed. For example, logging tools configured to measure electric, nuclear, gamma and/or magnetism levels may be used. Logging tools can also be implemented to measure other properties, events, and/or conditions such as, for example and without limitation, pressure, measure fluid viscosity, measure temperature, perform fluid identification, measure a tool orientation, and/or obtain any other measurements.

At various times during the process of drilling a well, the drill string 108 may be removed from the borehole 116 as shown in FIG. 1B. Once the drill string 108 has been removed, logging operations can be conducted using the downhole tool 126 (e.g., a logging tool, a sensing instrument sonde, etc.) suspended by a conveyance (e.g., conveyance 144 shown in FIG. 1B). In one or more examples, the conveyance can be or include a cable having conductors for transporting power to the tool and telemetry from the tool to the surface. In some examples, the downhole tool 126 can have pads and/or centralizing springs to maintain the tool near the central axis of the borehole or to bias the tool towards the borehole wall as the tool is moved downhole or uphole.

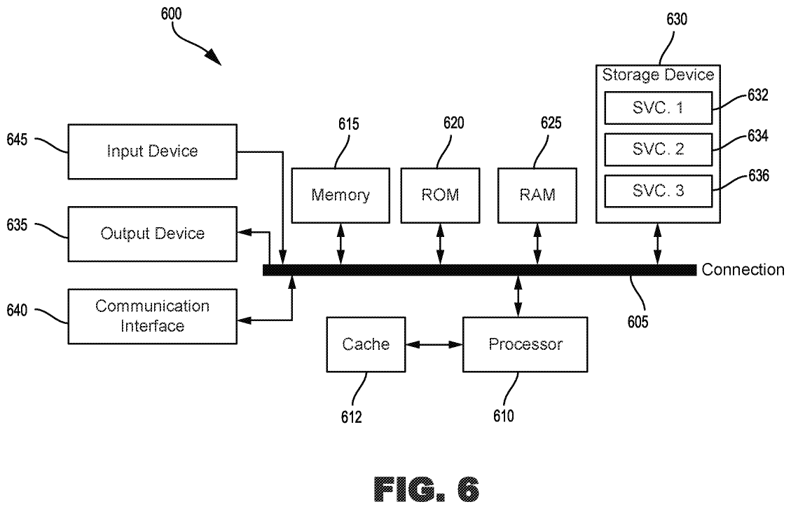

In some examples, the downhole tool 126 can include an acoustic or sonic logging instrument that collects acoustic logging data within the borehole 116. As mentioned above, other logging instruments may additionally or alternatively be used. A logging facility can include a computer system, such as the computer system 600 described with reference to FIG. 6, for collecting, storing, and/or processing the data/measurements gathered by the downhole tool 126. For example, the logging facility may include a logging data management system for modifying NMR logging data to be compatible with a temperature correction algorithm determined based on laboratory generated NMR data and applying the temperature correction algorithm to the modified logging data, if needed.

In one or more examples, a conveyance of the downhole tool 126 may include at least one of wires, conductive and/or non-conductive cable (e.g., slickline, etc.), and/or tubular conveyances such as coiled tubing, pipe string, or downhole tractor. In some cases, the downhole tool 126 can have a local power supply, such as batteries, a downhole generator, and/or the like. When employing a non-conductive cable, coiled tubing, pipe string, or a downhole tractor, communication can be supported using, for example, wireless protocols (e.g., EM, acoustic, etc.), and/or measurements and logging data may be stored in local memory for subsequent retrieval. In some aspects, electric or optical telemetry is provided using conductive cables and/or fiber optic signal-paths.

Referring to FIG. 1B, a tool having tool body 146 can be employed with “wireline” systems, in order to carry out logging or other operations. For example, instead of using the drill string 108 of FIG. 1A to lower tool body 146, which may contain sensors or other instrumentation for detecting and logging nearby characteristics and conditions of the wellbore and surrounding formation, the tool body 146 can be lowered by a wireline conveyance 144. Thus, as shown in FIG. 1B, the tool body 146 can be lowered into the wellbore 116 by the wireline conveyance 144. The wireline conveyance 144 can be anchored in a drill rig 142 or portable means such as a truck. The wireline conveyance 144 can include one or more wires, slicklines, cables, and/or the like, as well as tubular conveyances such as coiled tubing, joint tubing, or other tubulars.

The illustrated wireline conveyance 144 can provide support for the tool (e.g., tool body 146), enable communication between the tool processors on the surface, and/or provide a power supply. The wireline conveyance 144 can include fiber optic cabling for carrying out communications. The wireline conveyance 144 can be sufficiently strong and flexible to tether the tool body 146 through the wellbore 116, while also permitting communication through the wireline conveyance 144 to one or more local processors 148B and/or one or more remote processors 148A, 148N. Power can be supplied via the wireline conveyance 144 to meet power requirements of the tool. For slickline or coiled tubing configurations, power can be supplied downhole with a battery or via a downhole generator, for example.

Although FIGS. 1A and 1B depict specific borehole configurations, it should be understood that the present disclosure is suited for use in wellbores having other orientations including vertical wellbores, horizontal wellbores, slanted wellbores, multilateral wellbores, and the like. While FIGS. 1A and 1B depict an onshore operation, it should also be understood that the present disclosure is suited for use in offshore operations. Moreover, the present disclosure is not limited to the environments depicted in FIGS. 1A and 1B, and can also be used in other well operations such as, for example and without limitation, production tubing operations, jointed tubing operations, coiled tubing operations, combinations thereof, and/or the like.

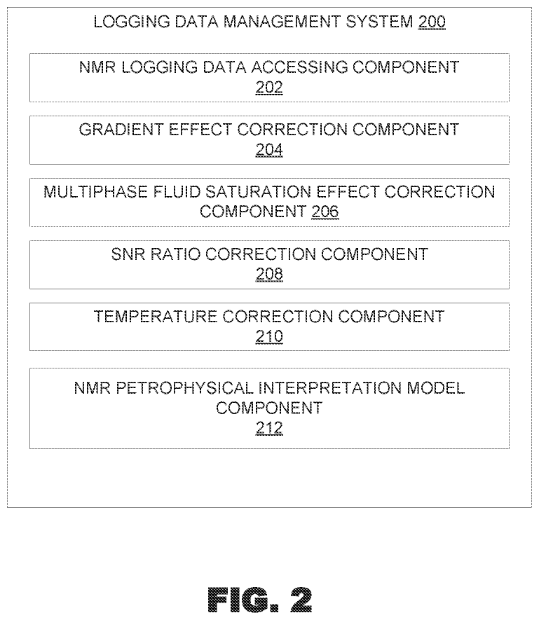

FIG. 2 illustrates a logging data management system 200, according to some examples of the present disclosure. The logging data management system 200 is configured to modify NMR logging data to be compatible with a temperature correction algorithm determined based on laboratory generated NMR data, and apply the temperature correction algorithm to the modified logging data, if needed. As shown, the logging data management system 200 includes an NMR logging data accessing component 202, a gradient effect correction component 204, a multiphase fluid saturation effect correction component 206, an SNR ratio correction component 208, a temperature correction component 210, and an NMR petrophysical interpretation model component 212.

The NMR logging data accessing component 202 accesses NMR logging data. The NMR logging data is captured using sensors during an active drill. For example, the NMR logging data can include NMR measurements determined based on data captured by the sensors. The NMR logging data accessing component 202 may access the NMR logging data from a data storage (e.g., memory), from the surface receiver 132 shown in FIG. 1A, and/or from one or more other devices/components. The NMR logging data accessing component 202 may provide the accessed NMR logging data to any of the other components of the logging data management system 200.

The gradient effect correction component 204 modifies NMR logging data to correct for a gradient effect on the NMR logging data. The NMR well logging tools and core analyzers can be capable of acquiring multiple echo trains with different magnetic field gradients, inter-echo spacings, and wait times. For instance, the spin-spin relaxation time derived from a Carr Purcell Meiboom Gill (CPMG) echo train acquired by a gradient-free NMR system is described by Equation 1: F₁(t, T_{2intrinsic})=M·exp(−t/T_{2intrinsic}), where the parameter T_{2intrinsic} is the intrinsic spin-spin-relaxation time that is purely a property of the sample under investigation. Laboratory generated NRM data is usually acquired with a substantially uniform magnetic field. On the other hand, many modern downhole NMR instruments acquire similar measurement in a non-zero gradient field. For the same rock and same saturating fluid, the NMR response in a gradient field is described by Equation 2:

$${F}_{2} ( t , {T}_{2 apparent} ) = M \cdot exp ( - t / {T}_{2 intrinsic} ) exp ( - \frac{1}{12} {γ}^{2} {G}^{2} {t}_{E}^{2} D ) ,$$

where G is the magnetic field and t_{E} is the inter-echo spacing and D is the diffusivity. The relationship between the apparent and intrinsic T₂ is described by Equation 3:

$$\frac{1}{{T}_{2 apparent}} = \frac{1}{{T}_{2 intrinsic}} + \frac{1}{12} {γ}^{2} {G}^{2} {t}_{E}^{2} D .$$

As shown, the diffusivity parameter is only detected in the presence of the field gradient. The zero-gradient NMR laboratory-derived temperature dependence of the relaxation time represents the temperature dependence correlation of T_{2intrinsic} The temperature dependence of a gradient-field logging measurement derived relaxation time represents the temperature dependence of T₂ₐₚₚₐᵣₑₙₜ. According to Equation 3, accounting for the temperature dependence in T_{2intrinsic} alone is insufficient to account for all the temperature effects in logging data, since the diffusivity in the second term of Equation 3 carries a different temperature dependence.

To account for temperature dependence effects on the NMR logging data, the gradient effect correction component 204 can use one of the following two methods. In the first approach, the gradient effect correction component 204 forward models the second term of Equation 3 at the reservoir temperature, if the type of fluid is known, such that the temperature of the diffusivity D of such fluid can be calculated. For instance, if the fluid is a water, the temperature dependence of water diffusivity is described by Equation 4:

$$D = {{D}_{0} [ \frac{T}{{T}_{s}} - 1 ]}^{2.063}$$

where D₀=1.635×10⁻⁸ (m²/s) and Tₛ=215.05 K. The other parameters in the second term in Equation 3 are known as they are either measurement parameters or tool parameters. Once the temperature dependence of the second term in Equation 3 is determined, the gradient effect correction component 204 adds it on the temperature dependence of the first term from the laboratory derived correlation, thereby deriving the temperature dependence of the logging derived T₂ distribution. This approach can be used if the fluid is simple such that the temperature dependent diffusivity is easy to obtain, and the geometric restriction to the molecular self-diffusion is negligible. However, these two conditions are not always met.

The second approach that can be used by the gradient effect correction component 204 does not require the knowledge of diffusivity value explicitly. Instead, gradient effect correction component 204 first converts the logging derived apparent T₂ distribution to lab-equivalent intrinsic T₂ distribution, using an inversion-forward modeling-inversion (IFMI), such as the one described in U.S. Pat. No. 11,002,875, which is incorporated herein by reference. Once the gradient effect correction component 204 has converted the logging derived T₂ₐₚₚₐᵣₑₙₜ distribution to T₂ apparent distribution, the gradient effect correction component 204 directly applies the lab derived temperature dependent correlation on the logging data temperature correction.

For an NMR tool that acquires data in various gradient strengths, the T₂ₐₚₚₐᵣₑₙₜ values may be different. Even for the same tool, frequently one designs different pulse sequences which may involve different sets of frequencies and, thus, different sets of gradient values, resulting in multiple T₂ₐₚₚₐᵣₑₙₜ values. NMR intrinsic relaxation time measurements are known to be correlated to pore size determination. The T₂ₐₚₚₐᵣₑₙₜ, on the other hand, distorts the information because it is shortened by the tool gradient effect. Thus, the ability to derive T_{2intrinsic} from T₂ₐₚₚₐᵣₑₙₜ is important for the accurate determination of pore size distributions.

The multiphase fluid saturation effect correction component 206 modifies NMR logging data to correct for the multifluid phase saturation rock on the NMR logging data. The temperature dependence of wetting and nonwetting phase fluids in porous rocks can be different. Realistically, it is impossible to conduct measurements at all arbitrary saturations in labs to develop temperature correction correlations for all temperatures. To address the multiphase saturated rock temperature dependent NMR relaxation time, multiphase fluid saturation effect correction component 206 first converts multiphase saturated (S_{w}<<1) logging NMR relaxation time response to the equivalence of 100% water saturation state (S_{w}=1) relaxation time response. The multiphase fluid saturation effect correction component 206 then applies the laboratory derived temperature dependence correlation obtained from single-phase fluid-saturated rocks to interpret multiphase logs. Such transformation can be accomplished by fluid substitution.

Various different methods can be employed for fluid substitutions to convert S_{w}<1 state NMR relaxation time distribution response to that corresponding to S_{w}=1 state. In some examples, the systems and techniques described herein can combine a fluid substitution method with temperature dependent correction of relaxation times. Moreover, some methods may only apply to scenarios where hydrocarbon and water phase relaxation times are distinctly non-overlapping. However, the systems and techniques described herein can implement a multimodality decomposition method in which different phase fluids are represented by at least one representative base function. Such base functions can be Gaussian, Gamma, or different distributions, or the combination of these. For instance, light oil filled pores may be represented by a Gaussian function, and water filled pores may be represented by a Gamma function.

As an example, a scenario where T₂ distributions of water filled pores and oil filled pores can be described by two Gaussian functions {log T_{2GM,k}, σₖ, cₖ}ₖ where k represents water and hydrocarbon, respectively. The overall T₂ distribution is T_{2,dist} (T₂)=S_{w}g_{w}(T₂)+(1−S_{w})g_{hc}(T₂) where

$${g}_{k} ( x ) = \frac{1}{σ \sqrt{2 π}} {e}^{- \frac{1}{2} {( \frac{log x - log {T}_{2 GM , k}}{{σ}_{k}} )}^{2}} .$$

In this way, even if hydrocarbon and water signals overlaps, the multiphase fluid saturation effect correction component 206 can decompose a T₂ distribution to water phase filled pore T₂ distribution and hydrocarbon filled pore T₂ distribution. Once S_{w} and T_{2GM,k} are determined, the multiphase fluid saturation effect correction component 206 can reconstruct T_{2GM@sw=1}^{ϕ}/T_{2GM}^{ϕw}=T_{2GM,gc→w}^{ϕhc} from the measured T_{2GM}^{ϕ}=T_{2GM}^{ϕw}T_{2GM}^{ϕhc}, where ϕ=ϕw+ϕhc. Subsequently, the temperature correction can be applied on T_{2GM@Sw=1}^{ϕ} data.

The above description assumes that the wetting phase fluid is brine. In general, the fluid to be substituted is the non-wetting phase. Thus, if a rock is substantially oil-wetting, the concept of fluid substitution applies, however, the substituted fluid will be brine, and the result after fluid substitution corresponds to the fully wetting phase fluid saturation (i.e., Sₒ=1).

The SNR ratio correction component 208 accounts for an SNR difference effect between laboratory generated NMR data and NMR logging data, and determines whether applying the temperature correction algorithm to the modified logging data is beneficial. Laboratory generated NMR data is often generated without a data acquisition time constraint. Thus, a large number of data average is often conducted to obtain high signal-to-noise (SNR) echo trains such that the repeatability of the T₂ distribution is superb. For logging operations, axial resolution and logging speed limits the number of levels of data that can be practically stacked, thus SNR of logging measurements usually do not match up to lab quality data. A lower SNR echo train results in a lower repeatability. Although the temperature effect causes a systematic shift in T₂ distribution, practically, correcting the temperature effect on T₂ distribution is only meaningful if the shift is greater than the standard deviation defined by the well logging repeatability of the T₂ distribution.

SNR is not the only factor that dictates the repeatability of a T₂ distribution. For a given SNR, the repeatability of a T₂ distribution can also be affected by its distribution pattern. To determine whether it is meaningful to apply a temperature correction for a distribution pattern determined from high SNR lab data, the SNR ratio correction component 208 can follow the following example procedure. The SNR ratio correction component 208 can generate random noise trains with the standard deviation of the noise comparable to logging measurements, and then co-add the noise trains to the echo trains from core NMR echo train measurements. The SNR ratio correction component 208 may repeat this portion N times, where N is a large number, such as a number greater than 100 for example, with the same standard deviation level but using different seeds of random noise trains. The SNR ratio correction component 208 then inverts the obtained noisy echo trains to further obtain T₂ distributions. The SNR ratio correction component 208 compute the standard deviation value of the T₂ distributions corresponding to each noise standard deviation. These noise standard deviations should be comparable to the downhole logging tool acquired data for (a) different salinities in WBM well, and (b) in OBM and fresh WBM drilled wells. The SNR ratio correction component 208 may store the correction of this information in a data storage as a retrievable look-up table for decision making. If the T₂ shift caused by the temperature difference between ambient and reservoir conditions is greater than the standard deviation of the T₂ distribution determined from the last step, the SNR ratio correction component 208 determines that it is beneficial to apply the correction. Alternatively, if the T₂ shift caused by the temperature difference between ambient and reservoir conditions is not greater than the standard deviation of the T₂ distribution determined from the last step, the SNR ratio correction component 208 determines that there is no need to make a correction of the NMR logging data.

The temperature correction component 210 applies temperature correction to NMR logging data using a temperature correction algorithm determined based on laboratory generated NMR data. If the SNR ratio correction component 208 determines that the temperature correlation should be applied to the NMR logging data, and the NMR logging data has been modified by the gradient effect correction component 204 and/or the multiphase fluid saturation effect correction component 206 (e.g., logging measured T₂ distribution has been preprocessed), the temperature correction component 210 can apply the temperature correction algorithm determined based on laboratory generated NMR data to the logging data correctly. For example, the temperature correction component 210 may apply the temperature correction algorithm using the parameter reduction method described in U.S. patent Ser. No. 10/969,513, which is incorporated by reference in its entirety and for all purposes. The temperature correction component 210 can apply scalar parameters derived from the T₂ distribution, and a dimension reduction method that employs a principal component analysis (PCA) to reduce a large number of elements representing a T₂ distribution by a small number (e.g., 4-8) of principal components, therefore, temperature correlations are established on the reduced dimension of PCs. This latter approach generates temperature corrected T₂ distribution vectors.

The parameter reduction model for NMR temperature dependence can be in the following form:

$$log ( \frac{{T}_{2 , GM , T}}{{T}_{2 , GM , {T}_{a}}} ) = C ( T - {T}_{a} ) + A ,$$

where C and A are rock quality dependent constants.

The following are non-limiting example correlations applicable for various different types of rock formations. The examples are provided for explanation purposes and are by no means exhaustive. For any particular formation rock types, the temperature dependent correlations can be obtained experimentally and replace the general equation form described in this disclosure.

Example 1: For high-quality carbonate reservoirs, the parameter reduction model for NMR temperature dependence can be the following:

$$log ( \frac{{T}_{2 , GM , T}}{{T}_{2 , GM , {T}_{a}}} ) = 0.0036 ( T - {T}_{a} ) - 0.0409 ,$$

where Tₐ is ambient temperature in ° F. units, T is reservoir temperature in ° F. units.

Example 2: For low-quality carbonate reservoirs, the parameter reduction model for NMR temperature dependence can be the following:

$$log ( \frac{{T}_{2 , GM , T}}{{T}_{2 , GM , {T}_{a}}} ) = 0.00212 ( T - {T}_{a} ) .$$

Example 3: For clastic reservoirs, the parameter reduction model for NMR temperature dependence can be the following:

$$log ( \frac{{T}_{2 , GM , T}}{{T}_{2 , GM , {T}_{a}}} ) = 0.00121 ( T - {T}_{a} ) .$$

The dimension reduction model for NMR temperature dependence can be in the following form: PCA_{i,T}=aᵢ+bᵢ*PCA_{i,T}_{ₐ}+cᵢ(T−Tₐ) i=1, 2, . . . , M, where PCA_{i,T}_{ₐ} is the i^{th} principal component of T₂ distributions at reservoir temperatures, and PCA_{i,T}_{ₐ} is i^{th} principal component of T₂ distributions at the ambient temperatures. M can be the number of principal components (PCs) used to model temperature dependences of T₂ distributions. Moreover, aᵢ, bᵢ, and cᵢ can represent reservoir dependent constants.

Example 4: For high-quality carbonate reservoirs, the dimension reduction model for NMR temperature dependence can be as follows:

PCA_{1,T}=−0.47194+0.81949PCA_{1,T}_{ₐ}−0.0091851(T−Tₐ)

PCA_{2,T}=−0.23011+0.91872PCA_{2,T}_{ₐ}+0.0051022(T−Tₐ)

PCA_{3,T}=0.28464+0.74409PCA_{3,T}_{ₐ}−0.0050796(T−Tₐ)

PCA_{4,T}=−0.040102+0.9897PCA_{4,T}_{ₐ}−0.0034567(T−Tₐ)

Example 5: For low-quality carbonate reservoirs, the dimension reduction model for NMR temperature dependence can be as follows:

PCA_{1,T}=0.95325PCA_{1,T}_{ₐ}−0.00274(T−Tₐ)

PCA_{2,T}=0.92611PCA_{2,T}_{ₐ}+0.00149(T−Tₐ)

PCA_{3,T}=0.87803PCA_{3,T}_{ₐ}−0.00169(T−Tₐ)

PCA_{4,T}=0.86861PCA_{4,T}_{ₐ}−0.00181(T−Tₐ)

PCA_{5,T}=0.89199PCA_{5,T}_{ₐ}−0.00286(T−Tₐ)

PCA_{6,T}=0.90191PCA_{1,T}_{ₐ}−0.00160(T−Tₐ)

PCA_{7,T}=0.86962PCA_{7,T}_{ₐ}+0.00027(T−Tₐ)

PCA_{8,T}_{ₐ}=0.94764PCA_{8,T}_{ₐ}−0.00022(T−Tₐ)

Example 6: For clastic reservoirs, the dimension reduction model for NMR temperature dependence can be as follows:

PCA_{1,T}=0.89807PCA_{1,T}_{ₐ}+0.00245(T−Tₐ)

PCA_{2,T}_{ₐ}=0.87309PCA_{2,T}_{ₐ}−0.00266(T−Tₐ)

PCA_{3,T}=0.91572PCA_{3,T}_{ₐ}−0.00344(T−Tₐ)

PCA_{4,T}=0.8335PCA_{4,T}_{ₐ}+0.00038(T−Tₐ)

PCA_{5,T}=0.90809PCA_{5,T}_{ₐ}−0.00343(T−Tₐ)

PCA_{6,T}=0.93856PCA_{1,T}_{ₐ}−0.00255(T−Tₐ)

The NMR petrophysical interpretation model component 212 applies one or more NMR petrophysical models to the temperature corrected NMR logging data. Petrophysical modeling is procedure used to interpret petrophysical (e.g., wireline log) data. Petrophysical models often have multiple routines representing a set of equations, algorithms, or other mathematical processes. For example, a deterministic model might include routines that calculate, shale volume, porosity, effective porosity, water saturation, and/or permeability.

The NMR petrophysical models can be calibrated using the laboratory generated NMR data. As the NMR logging data has been modified to be compatible with the laboratory generated NMR data, the NMR petrophysical interpretation model component 212 can apply the NMR petrophysical models to the temperature corrected NMR logging data.

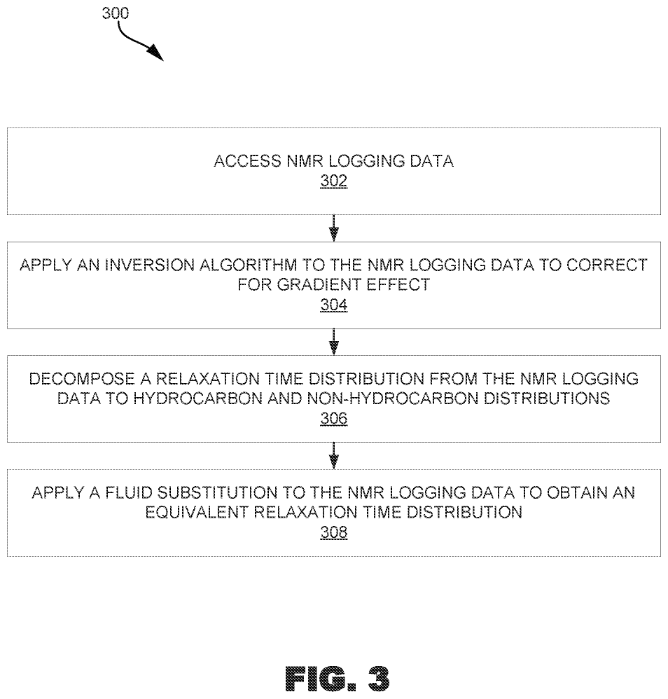

FIG. 3 is a flowchart illustrating an example process 300 for modifying NMR logging data to be compatible with a temperature correction algorithm, according to some aspects of the disclosed technology.

At block 302, the NMR logging data accessing component 202 can access NMR logging data. The NMR logging data can be captured using sensors during an active drill. For example, the NMR logging data can include NMR measurements determined based on data captured by the sensors. The NMR logging data accessing component 202 may access the NMR logging data from a data storage (e.g., memory), from the surface receiver 132 shown in FIG. 1A, and/or from a data acquisition module. The NMR logging data accessing component 202 may provide the accessed NMR logging data to any of the other components of the logging data management system 200.

At block 304, the gradient effect correction component 204 can apply an inversion algorithm to the NMR logging data to correct for gradient effect. The gradient effect correction component 204 converts the logging derived apparent T₂ distribution to lab-equivalent intrinsic T₂ distribution, using an inversion algorithm, such as IFMI. Once the gradient effect correction component 204 has converted the logging derived T₂ₐₚₚₐᵣₑₙₜ distribution to T₂ₐₚₚₐᵣₑₙₜ distribution, the gradient effect correction component 204 directly applies the lab derived temperature dependent correlation on the logging data temperature correction.

At block 306, the multiphase fluid saturation effect correction component 206 can decompose a relaxation time distribution from the NMR logging data to hydrocarbon and non-hydrocarbon distributions. At block 308, the multiphase fluid saturation effect correction component 206 can apply a fluid substitution to the NMR logging data to obtain an equivalent relaxation time distribution. The multiphase fluid saturation effect correction component 206 can modify NMR logging data to correct for the multifluid phase saturation rock on the NMR logging data. The temperature dependence of wetting and nonwetting phase fluids in porous rocks can be different. Realistically, it is impossible to conduct measurements at all arbitrary saturations in labs to develop temperature correction correlations for all temperatures. To address the multiphase saturated rock temperature dependent NMR relaxation time, multiphase fluid saturation effect correction component 206 can first convert multiphase saturated (S_{w}<<1) logging NMR relaxation time response to the equivalence of 100% water saturation state (S_{w}=1) relaxation time response. The multiphase fluid saturation effect correction component 206 can then apply the laboratory derived temperature dependence correlation obtained from single-phase fluid-saturated rocks to interpret multiphase logs. Such transformation can be accomplished by fluid substitution.

Various different methods can be employed for fluid substitutions to convert S_{w}<1 state NMR relaxation time distribution response to that corresponding to S_{w}=1 state. The systems and techniques described herein can combine any of such fluid substitution methods with a temperature dependent correction of relaxation times. Moreover, the fluid substitution methods can apply to scenarios where hydrocarbon and water phase relaxation times are distinctly non-overlapping. However, the systems and techniques of the present disclosure can implement a multimodality decomposition method in which different phase fluids are represented by at least one representative base function. Such base functions can be Gaussian, Gamma, or different distributions, or the combination of these. For instance, light oil filled pores may be represented by a Gaussian function, and water filled pores may be represented by a Gamma function.

As an example, a scenario where T₂ distributions of water filled pores and oil filled pores can be described by two Gaussian functions {log T_{2GM,k}, σₖ, cₖ}ₖ, where k represents water and hydrocarbon, respectively. The overall T₂ distribution is T_{2,dist} (T₂)=S_{w}g_{w}(T₂)+(1−S_{w})g_{hc}(T₂) where

$${g}_{k} ( x ) = \frac{1}{σ \sqrt{2 π}} {e}^{- \frac{1}{2} {( \frac{log x - log {T}_{2 GM , k}}{{σ}_{k}} )}^{2}} .$$

In this way, even if hydrocarbon and water signals overlaps, the multiphase fluid saturation effect correction component 206 can decompose a T₂ distribution to water phase filled pore T₂ distribution and hydrocarbon filled pore T₂ distribution. Once S_{w} and T_{2GM,k} are determined, the multiphase fluid saturation effect correction component 206 can reconstruct T_{2GM@sw=1}^{ϕ}/T_{2GM}^{ϕw}=T_{2GM,gc→w}^{ϕhc} from the measured T_{2GM}^{ϕ}=T_{2GM}^{ϕw}T_{2GM}^{ϕhc}, where ϕ=ϕw+ϕhc. Subsequently, the temperature correction can be applied on T_{2GM@Sw=1}^{ϕ} data.

The above description assumes that the wetting phase fluid is brine. In general, the fluid to be substituted is the non-wetting phase. Thus, if a rock is substantially oil-wetting, the concept of fluid substitution applies, however, the substituted fluid will be brine, and the result after fluid substitution corresponds to the fully wetting phase fluid saturation (e.g., Sₒ=1).

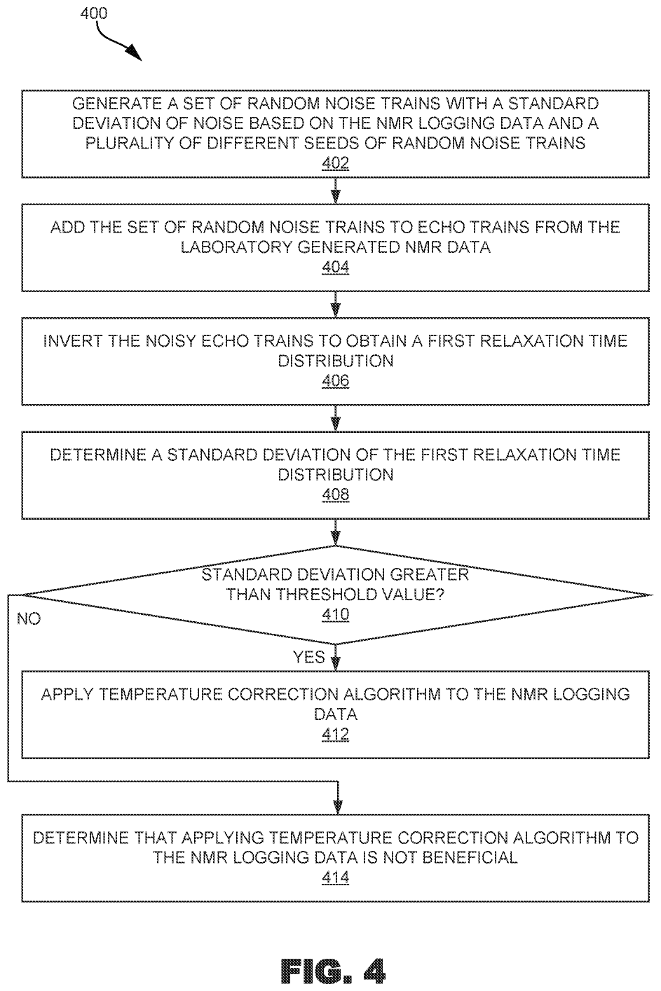

FIG. 4 is a flowchart illustrating an example process 400 for determining whether to apply temperature correction to NMR logging data, according to some aspects of the disclosed technology.

At block 402, the SNR ratio correction component 208 can generate a set of random noise trains with a standard deviation of noise based on the NMR logging data and a plurality of different seeds of random noise trains

At block 404, the SNR ratio correction component 208 can add the set of random noise trains to echo trains from the laboratory generated NMR data, to generate noisy echo trains.

At block 406, the SNR ratio correction component 208 can invert the noisy echo trains to obtain a first relaxation time distribution.

At block 408, the SNR ratio correction component 208 can determine a standard deviation of the first relaxation time distribution.

At block 410, the SNR ratio correction component 208 can determine whether the standard deviation of the first relaxation time distribution is greater than a threshold value.

If the standard deviation of the first relaxation time distribution is greater than the threshold value, at block 412 the temperature correction component 210 can apply the temperature correction algorithm to the NMR logging data (e.g., modified NMR logging data). Alternatively, if the standard deviation of the first relaxation time distribution is less than the threshold value, at block 414 the SNR ratio correction component 208 can determine that applying the temperature correction to the NMR logging data is not beneficial. In this type of situation, the temperature correction algorithm may not be applied to the modified NMR logging data. For example, the SNR ratio correction component 208 may instruct the temperature correction component 210 to not apply the temperature correction algorithm to the NMR logging data or, alternatively, refrain from instructing the temperature correction component 210 to apply the temperature correction algorithm to the NMR logging data.

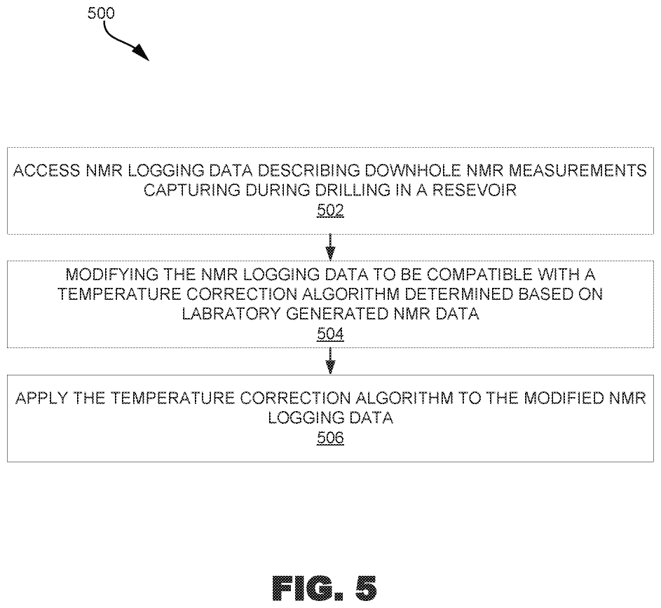

FIG. 5 is a flowchart illustrating an example process 500 for applying temperature correction to NMR logging data using a temperature correction algorithm determined based on laboratory generated NMR data, according to some aspects of the disclosed technology.

At block 502, the logging data management system 202 can access NMR logging data describing downhole NMR measurements captured during drilling in a reservoir. For example, the NMR logging data accessing component 202 accesses NMR logging data captured using sensors during an active drill. For example, the NMR logging data can include NMR measurements determined based on data captured by the sensors. The NMR logging data accessing component 202 may access the NMR logging data from a data storage (e.g., memory) and/or from the data acquisition module 132 shown in FIG. 1A.

At block 504, the logging data management system 202 can modify the NMR logging data to be compatible with a temperature correction algorithm. The temperature correction algorithm is determined based on laboratory generated NMR data. Modifying the NMR logging data yields modified NMR logging data.

The logging data management system 202 may modify the NMR logging data in multiple ways. For example, the gradient effect correction component 204, may generate a relaxation time distribution by applying an inversion algorithm to correct a gradient effect on the NMR logging data. Additionally or alternatively, the multiphase fluid saturation effect correction component 206 may applying a fluid substitution to the NMR logging data based on a fluid used to calculate the laboratory generated NMR data. For example, the multiphase fluid saturation effect correction component 206 may first decompose the relaxation time distribution to hydrocarbon and non-hydrocarbon distributions and then apply a fluid substitution to the NMR logging data based on the fluid used to calculate the laboratory generated NMR data.

At block 506, the temperature correction component 210 can apply the temperature correction algorithm to the modified NMR logging data, yielding temperature corrected NMR logging data.

FIG. 6 illustrates an example processor-based system 600 with which some aspects of the subject technology can be implemented. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 can include an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L#), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, causes the system to perform a function. In some examples, a hardware service that performs a particular function can include the software component stored in a computer-readable medium in connection with the necessary hardware components, such as processor 610, connection 605, output device 635, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Example 1. A method comprising: obtaining nuclear magnetic resonance (NMR) logging data describing downhole NMR measurements captured during a drilling operation in a borehole; modifying the NMR logging data to be compatible with a temperature correction algorithm, yielding modified NMR logging data, the temperature correction algorithm having been determined based on laboratory generated NMR data; and applying the temperature correction algorithm to the modified NMR logging data, yielding temperature corrected NMR logging data.

Example 2. The method of Example 1, further comprising: applying an NMR petrophysical model to the temperature corrected NMR logging data, the NMR petrophysical model having been generated based on the laboratory generated NMR data.

Example 3. The method of any of Examples 1 to 2, wherein modifying the NMR logging data to be compatible with the temperature correction algorithm comprises: generating a relaxation time distribution by applying an inversion algorithm to correct a gradient effect on the NMR logging data.

Example 4. The method of Example 3, wherein modifying the NMR logging data to be compatible with the temperature correction algorithm further comprises: applying a fluid substitution to the NMR logging data based on a fluid used to calculate the laboratory generated NMR data.

Example 5. The method of any of Examples 3 or 4, wherein modifying the NMR logging data to be compatible with the temperature correction algorithm comprises: decomposing the relaxation time distribution to hydrocarbon and non-hydrocarbon distributions.

Example 6. The method of any of Examples 1 to 5, further comprising: generating a set of random noise trains with a standard deviation of noise based on the NMR logging data and a plurality of different seeds of random noise trains; adding the set of random noise trains to echo trains from the laboratory generated NMR data, yielding noisy echo trains; inverting the noisy echo trains to obtain a first relaxation time distribution; determining a standard deviation of the first relaxation time distribution; and applying the temperature correction algorithm to the modified NMR logging data based on a determination that the standard deviation of the first relaxation time distribution is greater than a threshold value.

Example 7. The method of Example 6, wherein the threshold value is determined based on a shift in a second relaxation time distribution caused by a temperature difference between ambient and reservoir conditions determined from the NMR logging data.

Example 8. A system comprising: one or more processors; and at least one computer-readable medium having stored thereon instructions which, when executed by the one or more processors, cause the one or more processors to: access nuclear magnetic resonance (NMR) logging data describing downhole NMR measurements captured during drilling in a reservoir; modify the NMR logging data to be compatible with a temperature correction algorithm, yielding modified NMR logging data, wherein the temperature correction algorithm is determined based on laboratory generated NMR data; and apply the temperature correction algorithm to the modified NMR logging data, yielding temperature corrected NMR logging data.

Example 9. The system of Example 8, wherein the instructions, when executed by the one or more processors, cause the one or more processors to: apply an NMR petrophysical model to the temperature corrected NMR logging data, the NMR petrophysical model having been generated based on the laboratory generated NMR data.

Example 10. The system of any of Examples 8 to 9, wherein modifying the NMR logging data to be compatible with the temperature correction algorithm comprises: generating a relaxation time distribution by applying an inversion algorithm to correct a gradient effect on the NMR logging data.

Example 11. The system of Example 10, wherein modifying the NMR logging data to be compatible with the temperature correction algorithm further comprises: applying a fluid substitution to the NMR logging data based on a fluid used to calculate the laboratory generated NMR data.

Example 12. The system of any of Examples 10 or 11, wherein modifying the NMR logging data to be compatible with the temperature correction algorithm comprises: decomposing the relaxation time distribution to hydrocarbon and non-hydrocarbon distributions.

Example 13. The system of any of Examples 8 to 12 wherein the instructions, when executed by the one or more processors, cause the one or more processors to: generate a set of random noise trains with a standard deviation of noise based on the NMR logging data and a plurality of different seeds of random noise trains; add the set of random noise trains to echo trains from the laboratory generated NMR data, yielding noisy echo trains; invert the noisy echo trains to obtain a first relaxation time distribution; determine a standard deviation of the first relaxation time distribution; and apply the temperature correction algorithm to the modified NMR logging data based on a determination that the standard deviation of the first relaxation time distribution is greater than a threshold value.

Example 14. The system of Example 13, wherein the threshold value is determined based on a shift in a second relaxation time distribution caused by a temperature difference between ambient and reservoir conditions determined from the NMR logging data.

Example 15. A non-transitory computer-readable medium having stored thereon instructions that, when executed by one or more processors, cause the one or more devices to: access nuclear magnetic resonance (NMR) logging data describing downhole NMR measurements captured during drilling in a reservoir; modify the NMR logging data to be compatible with a temperature correction algorithm, yielding modified NMR logging data, the temperature correction algorithm having been determined based on laboratory generated NMR data; and apply the temperature correction algorithm to the modified NMR logging data, yielding temperature corrected NMR logging data.

Example 16. The non-transitory computer-readable medium of Example 15, the operations further comprising: applying an NMR petrophysical model to the temperature corrected NMR logging data, the NMR petrophysical model having been generated based on the laboratory generated NMR data.

Example 17. The non-transitory computer-readable medium of any of Examples 15 to 16, wherein modifying the NMR logging data to be compatible with the temperature correction algorithm comprises: generating a relaxation time distribution by applying an inversion algorithm to correct a gradient effect on the NMR logging data.

Example 18. The non-transitory computer-readable medium of Example 17, wherein modifying the NMR logging data to be compatible with the temperature correction algorithm further comprises: applying a fluid substitution to the NMR logging data based on a fluid used to calculate the laboratory generated NMR data.

Example 19. The non-transitory computer-readable medium of any of Examples 17 or 18, wherein modifying the NMR logging data to be compatible with the temperature correction algorithm comprises: decomposing the relaxation time distribution to hydrocarbon and non-hydrocarbon distributions.

Example 20. The non-transitory computer-readable medium of any of Examples 15 to 19, wherein the instructions, when executed by the one or more processors, cause the one or more processors to: generate a set of random noise trains with a standard deviation of noise based on the NMR logging data and a plurality of different seeds of random noise trains; add the set of random noise trains to echo trains from the laboratory generated NMR data, yielding noisy echo trains; invert the noisy echo trains to obtain a first relaxation time distribution; determining a standard deviation of the first relaxation time distribution; and apply the temperature correction algorithm to the modified NMR logging data based on a determination that the standard deviation of the first relaxation time distribution is greater than a threshold value, wherein the threshold value is determined based on a shift in a second relaxation time distribution caused by a temperature difference between ambient and reservoir conditions determined from the NMR logging data.

Example 21. A system comprising means for performing a method according to any of Examples 1 to 7.

Example 22. A computer-program product having stored thereon instructions which, when executed by one or more processors, cause the one or more processors to perform a method according to any of Examples 1 to 7.

What is claimed is:

1. A method comprising:
obtaining nuclear magnetic resonance (NMR) logging data describing one or more downhole NMR measurements captured during a drilling operation in a borehole;
modifying the NMR logging data to be compatible with a temperature correction algorithm, yielding modified NMR logging data, the temperature correction algorithm having been determined based on laboratory generated NMR data; and
applying the temperature correction algorithm to the modified NMR logging data, yielding temperature corrected NMR logging data.

2. The method of claim 1, further comprising:
applying an NMR petrophysical model to the temperature corrected NMR logging data, the NMR petrophysical model having been generated based on the laboratory generated NMR data.

3. The method of claim 1, wherein modifying the NMR logging data to be compatible with the temperature correction algorithm comprises:
generating a relaxation time distribution by applying an inversion algorithm to correct a gradient effect on the NMR logging data.

4. The method of claim 3, wherein modifying the NMR logging data to be compatible with the temperature correction algorithm further comprises:
applying a fluid substitution to the NMR logging data based on a fluid used to calculate the laboratory generated NMR data.

5. The method of claim 4, wherein modifying the NMR logging data to be compatible with the temperature correction algorithm comprises:
decomposing the relaxation time distribution to hydrocarbon and non-hydrocarbon distributions.

6. The method of claim 1, further comprising:
generating a set of random noise trains with a standard deviation of noise based on the NMR logging data and a plurality of different seeds of random noise trains;
adding the set of random noise trains to echo trains from the laboratory generated NMR data, yielding noisy echo trains;
inverting the noisy echo trains to obtain a first relaxation time distribution;
determining a standard deviation of the first relaxation time distribution; and
applying the temperature correction algorithm to the modified NMR logging data based on a determination that the standard deviation of the first relaxation time distribution is greater than a threshold value.

7. The method of claim 6, wherein the threshold value is determined based on a shift in a second relaxation time distribution caused by a temperature difference between ambient and reservoir conditions determined from the NMR logging data.

8. A system comprising:
one or more processors; and
at least one computer-readable medium having stored thereon instructions that, when executed by the one or more processors, cause the one or more processors to:
obtain nuclear magnetic resonance (NMR) logging data describing downhole NMR measurements captured during drilling in a reservoir;
modify the NMR logging data to be compatible with a temperature correction algorithm, yielding modified NMR logging data, the temperature correction algorithm having been determined based on laboratory generated NMR data; and
apply the temperature correction algorithm to the modified NMR logging data, yielding temperature corrected NMR logging data.

9. The system of claim 8, wherein the instructions, when executed by the one or more processors, cause the one or more processors to:
apply an NMR petrophysical model to the temperature corrected NMR logging data, the NMR petrophysical model having been generated based on the laboratory generated NMR data.

10. The system of claim 8, wherein modifying the NMR logging data to be compatible with the temperature correction algorithm comprises:
generating a relaxation time distribution by applying an inversion algorithm to correct a gradient effect on the NMR logging data.

11. The system of claim 10, wherein modifying the NMR logging data to be compatible with the temperature correction algorithm further comprises:
applying a fluid substitution to the NMR logging data based on a fluid used to calculate the laboratory generated NMR data.

12. The system of claim 11, wherein modifying the NMR logging data to be compatible with the temperature correction algorithm comprises:
decomposing the relaxation time distribution to hydrocarbon and non-hydrocarbon distributions.

13. The system of claim 8, wherein the instructions, when executed by the one or more processors, cause the one or more processors to:
generate a set of random noise trains with a standard deviation of noise based on the NMR logging data and a plurality of different seeds of random noise trains;
add the set of random noise trains to echo trains from the laboratory generated NMR data, yielding noisy echo trains;
invert the noisy echo trains to obtain a first relaxation time distribution;
determine a standard deviation of the first relaxation time distribution; and
apply the temperature correction algorithm to the modified NMR logging data based on a determination that the standard deviation of the first relaxation time distribution is greater than a threshold value.

14. The system of claim 13, wherein the threshold value is determined based on a shift in a second relaxation time distribution caused by a temperature difference between ambient and reservoir conditions determined from the NMR logging data.

15. A non-transitory computer-readable medium having stored thereon instructions that, when executed by one or more processors, cause the one or more processors to:
obtain nuclear magnetic resonance (NMR) logging data describing downhole NMR measurements captured during drilling in a reservoir;
modify the NMR logging data to be compatible with a temperature correction algorithm, yielding modified NMR logging data, the temperature correction algorithm having been determined based on laboratory generated NMR data; and
apply the temperature correction algorithm to the modified NMR logging data, yielding temperature corrected NMR logging data.

16. The non-transitory computer-readable medium of claim 15, wherein the instructions, when executed by the one or more processors, cause the one or more processors to:
apply an NMR petrophysical model to the temperature corrected NMR logging data, the NMR petrophysical model having been generated based on the laboratory generated NMR data.

17. The non-transitory computer-readable medium of claim 15, wherein modifying the NMR logging data to be compatible with the temperature correction algorithm comprises:
generating a relaxation time distribution by applying an inversion algorithm to correct a gradient effect on the NMR logging data.

18. The non-transitory computer-readable medium of claim 17, wherein modifying the NMR logging data to be compatible with the temperature correction algorithm further comprises:
applying a fluid substitution to the NMR logging data based on a fluid used to calculate the laboratory generated NMR data.

19. The non-transitory computer-readable medium of claim 18, wherein modifying the NMR logging data to be compatible with the temperature correction algorithm comprises:
decomposing the relaxation time distribution to hydrocarbon and non-hydrocarbon distributions.

20. The non-transitory computer-readable medium of claim 15, wherein the instructions, when executed by the one or more processors, cause the one or more processors to:
generate a set of random noise trains with a standard deviation of noise based on the NMR logging data and a plurality of different seeds of random noise trains;
add the set of random noise trains to echo trains from the laboratory generated NMR data, yielding noisy echo trains;
invert the noisy echo trains to obtain a first relaxation time distribution;
determine a standard deviation of the first relaxation time distribution; and
apply the temperature correction algorithm to the modified NMR logging data based on a determination that the standard deviation of the first relaxation time distribution is greater than a threshold value, wherein the threshold value is determined based on a shift in a second relaxation time distribution caused by a temperature difference between ambient and reservoir conditions determined from the NMR logging data.
